(19) United States
(12) Patent Application Publication
(10) Pub. No.: US 2007/0041177 A1
(43) Pub. Date: Feb. 22, 2007

(54) Bidirection-rotational conducting device

(76) Inventor: Tsung-Ming Lin, Taipei Hsien (TW)

Correspondence Address: LIN TSUNG-MING, 235 Chung-Ho, Box 8-24, Taipei, TW

(21) Appl. No.: 11/204,241

(22) Filed: Aug. 16, 2005

(51) Int. Cl. B43K 29/10

(52) U.S. Cl. 362/118

(57) ABSTRACT

A bidirection-rotational conducting device has a pen cap. The pen cap can be twisted in two opposite directions, and a light emitting body cab be turned on and switch off accordingly. At the same time, a refill unit of the bidirection-rotational conducting device will extend outwardly in accordance to the illumination of the light emitting body, assisting the writing of the user. Further, the color of the light emitting body can be replaced, offering a special visual appeal. The conducting device comprises a holding unit having a holdable outer wall; a refill unit housed within said holding unit; a light unit also housed within said holding unit further including a light emitting body; and a rotational unit housed within a pen cap and connected to said holding unit by a screwed structure.

### FIELD OF THE INVENTION

The present invention relates to conducting devices, more particularly to a bidirection-rotational conducting device used in a writing tool by which it can emit light and its refill can retreat, providing a user with visual appeals.

### BACKGROUND OF THE INVENTION

A light emitting pen of the prior art comprises an upper pen body having a slot, an inner pen body, a light emitting body and a circuit board controlling the switching and providing power for the light emitting body. The slot is further provided with a touch button for guiding the inner pen body slidably installed in the upper pen body; the outer wall of the inner pen body is provided with a guiding notch for the guiding. The circuit is provided with a battery and a touch sensitive switch in a position corresponding to the touch button. The light emitting body is disposed next to the circuit board and is provided with a conducting spring on the bottom thereof. A lower pen body can be coupled with the upper pen body by screwing. The upper end of the upper pen body is screw connected with a cover. Thereby, the above components form a light emitting pen of the prior art. To use the light emitting pen of the prior art, a user press the touch button in order to activate the touch sensitive switch, whereby the battery and the light emitting body are conducted. If the user pushes the touch button no more, the light emitting body will stop illuminating. Although the light emitting pen can be used as a flashlight, it cannot provide light at the same time when the user is writing. Therefore, the user still needs other light sources, such as a desk lamp and a secondary flashlight, to facilitate writing.

### SUMMARY OF THE INVENTION

The primary objective of the present invention is to provide a bidirection-rotational conducting device wherein a pen cap can be twisted in two opposite directions, and a light emitting body cab be turned on and switch off accordingly. At the same time, a refill unit of the bidirection-rotational conducting device will extend outwardly in accordance to the illumination of the light emitting body, assisting the writing of the user. Further, the color of the light emitting body can be replaced, offering a special visual appeal.

To achieve above object, the present invention provides a bidirection-rotational conducting device,. The device comprises a holding unit having a holdable outer wall; a refill unit housed within said holding unit; a light unit also housed within said holding unit further including a light emitting body; and a rotational unit housed within a pen cap and connected to said holding unit by a screwed structure.

The various objects and advantages of the present invention will be more readily understood from the following detailed description when read in conjunction with the appended drawings.

### BRIEF DESCRIPTION OF THE DRAWINGS

FIG. 1 is an exploded perspective view of a bidirection-rotational conducting device of the present invention.

FIG. 2 is a perspective view of the bidirection-rotational conducting device in FIG. 1.

FIG. 3 is a perspective view of the rotational unit of the bidirection-rotational conducting device comprises in FIG. 1.

FIG. 4 is a side cross-sectional view of the bidirection-rotational conducting device in FIG. 1.

FIG. 5 illustrates a counter-clockwise rotation of the pen cap of the bidirection-rotational conducting device comprises.

FIG. 6 illustrates a clockwise rotation of the pen cap of the bidirection-rotational conducting device comprises.

### DETAILED DESCRIPTION OF THE PREFERRED EMBODIMENTS

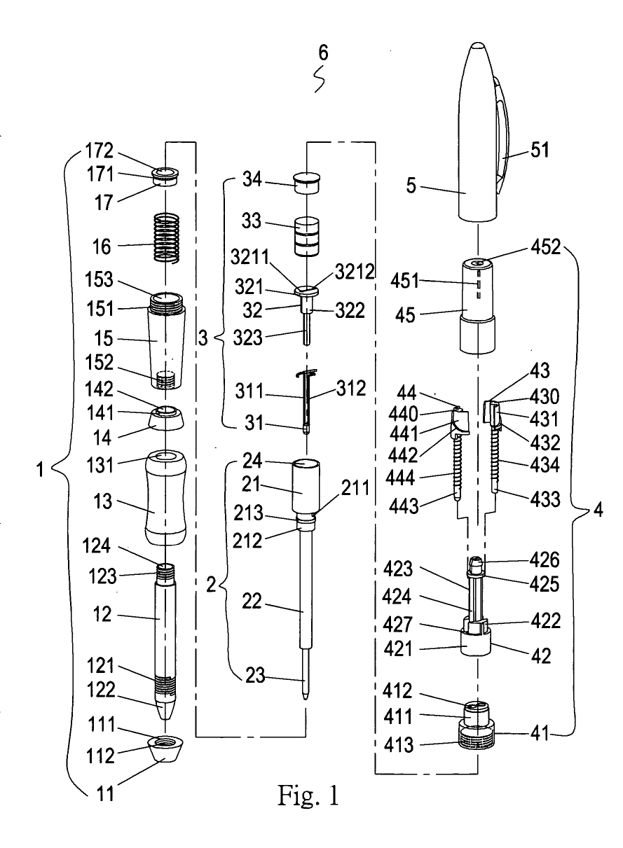

Referring to FIG. 1 to FIG. 3, a bidirection-rotational conducting device 6 according to the present invention comprises a holding unit 1, a refill unit 2, a light unit 3, a rotational unit 4 and a pen cap 5.

The holding unit 1 further comprises a lower ring stopper 11, a first tube 12, a holding part 13, an upper ring stopper 14, a second tube 15, a conducting spring 16 and a spring cap 17. The first tube 12 is provided with an axial hole 124 that has a screwed section 121 at its lower end where a gradually converged end 122 is extended downwardly. The gradually converged end 122 is attached with the lower ring stopper 11 which has a through hole 111 therein for the insertion of the first tube 12. The inner wall of the through hole 111 of the lower ring stopper 11 is provided with a screwed section 112 for engaging a lower screwed section 121 in the first tube 12. On the inner wall of the holding part 13, there is an axial hole 131 for being coupled with an upper screwed section 123 on the outer wall of the first tube 12, whereby the holding part 13 can be mounted onto the outer wall of the first tube 12. The lower end of the holding part 13 can be supported by the top face of the lower ring stopper 11. The upper end of the holding part 13 is further provided with the upper ring stopper 14. The top surface of the upper ring stopper 14 is provided with an annular flange 141, and a through hole 142 is formed within the upper ring stopper 14, whereby the upper ring stopper 14 will be coupled with the outer wall of the first tube 12 by the through hole 142. Above the upper ring stopper 14, there is a second tube 15, which second tube 15 is provided with an internal axial hole 153 having an inner screwed section 152 in a lower part thereof, whereby the second tube 15 can be connected with the first tube 12 by the engagement between the inner screwed section 152 and the upper screwed section 123. Further, the lower end of the second tube 15 is mounted on the top face of the upper ring stopper 14. The annular flange 141 of the upper ring stopper 14 is connected to the lower end of the second tube 15, whereby the first tube 12 and the second tube 15 are united. The upper outer wall of the second tube 15 is provided with an outer screwed section 151, and the axial hole 153 of the second tube 15 houses the conducting spring 16. On top of the conducting spring 16 there is a spring cap 17 that has a through hole 172. The conducting spring 16 is retained by an annular groove 171 formed around the upper end of the spring cap 17. The set of the axial hole 124, the axial hole 153 and the through hole 172 forms an elongated internal space within the holding unit 1 for the insertion of the refill unit 2.

The refill unit 2 further comprises an upper tube 21 and a lower tube 22. An inwardly converged neck 212 is extended from the lower end of the upper tube 21. A hole 211 is formed at where the upper tube 21 and the inwardly converged neck 212 are connected for the insertion of a positive-polarity bracket 312. The positive-polarity bracket 312 has an arced head that can be attached onto the outer wall of the neck 212. Further, the outer wall of the neck 212 is provided with an annular projection 213 for retaining the spring cap 17 at the neck 212 and at the same time confining the arced head of the positive-polarity bracket 312. The inwardly converged lower tube 22 is extended from the lower end of the neck 212. A refill 23 is mounted at the lower end of the lower tube 22. The internal space from the upper tube 21 to the lower tube 22 defines an axial hole for housing the light unit 3.

The light unit 3 further comprises a light-emitting body 31, a supporting unit 32, a set of batteries 33 and a battery cap 34. A negative-polarity bracket 311 and a positive-polarity bracket 312 are extended from the top face of the light-emitting body 31. The free end of the negative-polarity bracket 311 is bent to form a vertical structure, whereas the free end of the positive-polarity bracket 312 is bent to form the arced head. Each of the free ends of the brackets is provided with a supporting unit 32 having an annular stopper 321. Each of the annular stoppers 321 further includes a guiding notch 3212 and a hole 3211 at one end of the associated guiding notch 3212, which hole 3211 is for the insertion of the negative-polarity bracket 311, whereby the vertically bent head at the free end of the negative-polarity bracket 311 will situate in one of the guiding notches 3212 of a corresponding supporting unit 32, for securing at the negative terminal of the set of batteries 33. The set of batteries supplies the power of the light emitting body. An inwardly converging neck portion 322 is extended from the lower end of the annular stoppers 321, and the neck portion 322 in turn has a downwardly extended thin rod 323 between the negative-polarity bracket 311 and the positive-polarity bracket 312. The thin rod 323 is further secured by the annular stopper 321 of the supporting unit 32 on bottom face of the upper tube 21 of the refill unit 2, at a predetermined location. Thereby, the light emitting body 31 will be retained within the lower tube 22 of the refill unit 2. A battery cap 34 is mounted on the set of batteries 33 disposed within the upper tube 21 of the refill unit 2.

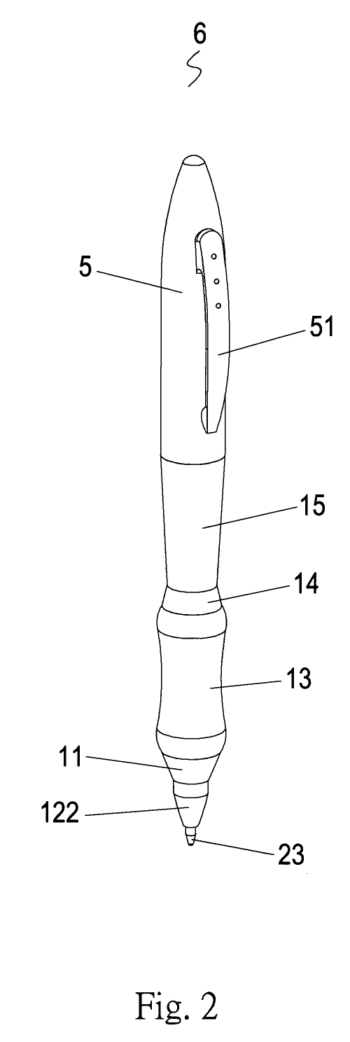

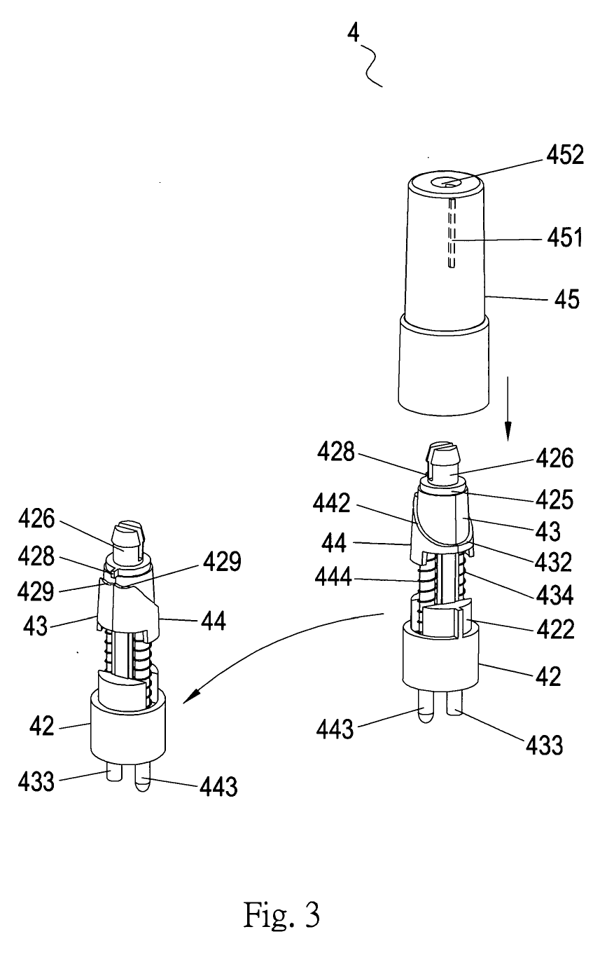

The rotational unit 4 further comprises a retaining sleeve 41, a connecting portion 42, an A core component 43, a B core component 44 and a shell 45. The top surface of the retaining sleeve 41 is extended with a hollow column 411 with an internal receptacle. The column 411 further includes a retaining hole 412, and the lower inner all thereof is provided with a screwed section 413. The column 411 can be mounted onto the base 421 of a connecting portion 42. The top face of the base 421 is provided with two opposite projections 422 and a guiding column 423 between the projections 422. Two lateral sides of the guiding column 423 are provided with respective guiding grooves 424. Each of the arced projections 422 is provided with a through hole 427 going though the base 421, and the top surface of the guiding column 423 is provided with an annular stopper 425 with side projected pieces 428. Two hooked heads 426 are formed on the top surface of the annular stopper 425, in opposite positions. The insertion tube 443 of the B core component 44 is capable of being inserting through one of the through holes 427 at the lower terminal of the left guiding groove 424, whereas the metallic insertion tube 433 of the A core component 43 is capable of being inserting through one of the through holes 427 at the lower terminal of the right guiding groove 424. The metallic insertion tube 433 and the insertion tube 443 respectively have springs 434, 444 and go through two retaining holes 412 on the retaining sleeve 41 at the same time. On the top of the metallic insertion tube 433, there is a guiding column 430 with a ring plate 431. The outer wall of the ring plate 431 is bulged with an arced guiding rail 432 that have a dipped retaining point 429 at the upper terminal thereof for securing the refill 23 in its extended configuration. A guiding column 440, a ring plate 441 and a arced guiding rail 442 are extended upwardly on the top of the B core component 44, for the sliding of the guiding columns 430, 440 along the annular guiding grooves 424. The spring 434, 444 respectively of the A core component 43 and the B core component 44 can support and confine the A, B core components 43, 44 within the guiding groove 424 of the guiding column 423. Therefore, the connecting portion 42, the A core component 43, the B core component 44 can be contained within the shell 45. The inner doom of the shell 45 is provided with a supporting portion 451 that will follow the track of the guiding rails 432, 442 and be eventually retained by the retaining point 429, as the shell 45 is rotated. Thereby, the shell 45 can definitely control the sliding motion of the A, B core components 43, 44 simultaneously, so as to achieve the retreat and the extension of the refill 23 about the pen nozzle 122, as shown in FIG. 3. The lower inner wall of the shell 45 us for enclosing the column 411, and the hooked heads 426 of the connecting portion 42 can go through the through holes 452 on the shell 45. Thereby, as the hooked heads 426 are pushed inwardly, the shell 45 and the retaining sleeve 41 will be departed, whereby the rotational unit 4 will be stably confined within the pen cap 5. The outer wall of the pen cap 5 is provided with a pen clip 51. The pen cap 5 and the holding unit 1 are combined by the engagement between the screwed section 413 of the retaining sleeve 41 and the screwed section 151 of the second tube 15, as shown in FIG. 2.

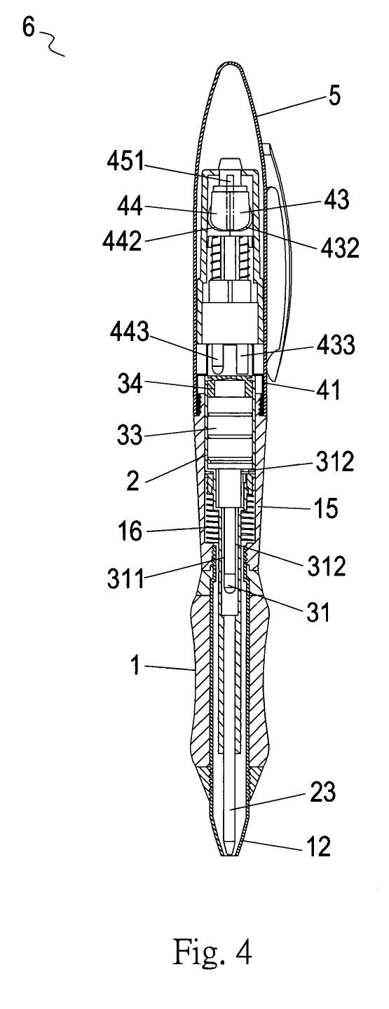

Referring to FIG. 4, the bidirection-rotational conducting device of the present invention 6 in an unused situation has the supporting section 451 of the shell 45 situating at the bottom of the arced guiding rails 432, 442, whereby the metallic insertion tube 433 and the insertion tube 443 will be held in their respective original locations. Meanwhile, the refill unit 2, supported by the conducting spring 16, is located on the inner upper wall of the holding unit 1. Further, there exists a gap between the battery cap 34 and the insertion tubes 443, 443, thereby prohibiting the formation of a conducting loop by the metallic insertion tube 433, the spring 434, the retaining sleeve 41, the second tube 15 and the positive-polarity bracket 312 (the positive-polarity bracket 3 12 is thus connected to the second tube 15) and the supply of power from the batteries 33 to the light emitting body 31. At the same time, the refill 23 is retreated into the first tube 12.

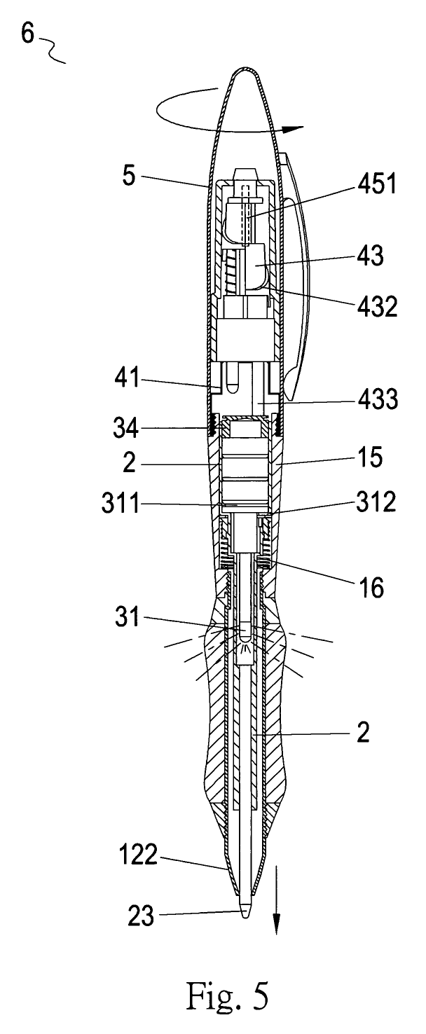

Referring to FIG. 3 and FIG. 5, as the pen cap 5 of the bidirection-rotational conducting device is twisted in the counter-clockwise direction, it will follows the arced track of the guiding rail 432 at the lower end of the supporting portion 451 on the inner wall of the shell 5, resulting in a downward shift of the A core component and a according contraction of the spring 434 on the metallic insertion tube 433 (as shown in FIG. 3). Thereby, the metallic insertion tube 433 will be brought into contact with the battery cap 34, and the metallic insertion tube 433, the spring 434, the retaining sleeve 41, the second tube 15, conducting spring 16, the spring cap 17 and the positive-polarity bracket 312 will form a conducting loop. The light emitting body 31 will thus be powered by the batteries 33 and start to illuminate.

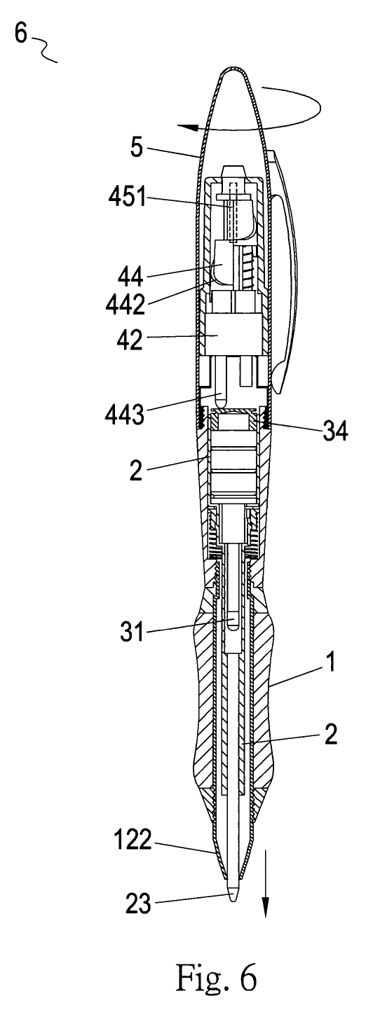

Referring to FIG. 3 and FIG. 6, as the pen cap 5 of the bidirection-rotational conducting device is twisted in the clockwise direction, it will follows the arced track of the guiding rail 442 at the lower end of the supporting portion 451 on the inner wall of the shell 45, resulting in a downward shift of the B core component and according contraction of the spring 444 on the insertion tube 443 (as shown in FIG. 3). Thereby, the insertion tube 443 will be brought into contact with the battery cap 34, pushing the battery cap 34 and the second tube 15 downward and consequently contracting the conducting spring 16. This will result in the extension of the refill 23 from the pen nozzle 122 of first tube 12. The lower end of the supporting portion 451 on the inner wall of the shell 45 will be locked with the retaining point 429 of the guiding rail 432, as shown in FIG. 3. Therefore, the motion of the shell 45 can indeed control the sliding motion of the B core component 44.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bidirection-rotational conducting device, comprising:
a holding unit having a holdable outer wall;
a refill unit housed within said holding unit;
a light unit also housed within said holding unit further including a light emitting body; and
a rotational unit housed within a pen cap and connected to said holding unit by a screwed structure.

2. The bidirection-rotational conducting device of claim 1 wherein said holding unit further comprises a lower ring stopper and a first tube, each having a central hole in an axial direction and a screwed section for engaging one another to form a unified structure.

3. The bidirection-rotational conducting device of claim 1 wherein said first tube is cupped by said holding unit in said axial direction along which said central hole extends; a bottom face of said holding unit being blocked by said lower ring stopper.

4. The bidirection-rotational conducting device of claim 1 wherein an upper end of said first tube is connected to a hollow second tube by a screwed section formed on an inner wall thereof; an inner space in said second tube defining a through hole for housing a conducting spring; an upper end of said conducting spring being provided with a spring cap with an annular groove for retaining said conducting spring; a lower end of said second tube being blocked by an upper ring stopper; said second tube further including a ring projection on a lower inner wall thereof for engaging said first tube to form a unified structure.

5. The bidirection-rotational conducting device of claim 1 wherein said holding unit has a plurality of through holes for the insertion of said refill unit.

6. The bidirection-rotational conducting device of claim 1 wherein a lower end of said second tube is extended with an inwardly tapered neck portion with an axial central through hole for the insertion of a positive-polarity bracket; an arced head plate extended from said positive-polarity bracket being attached on an outer wall of said neck portion; an annular projection being formed on an outer wall of said neck portion for retaining said spring cap and for securing said positive-polarity bracket.

7. The bidirection-rotational conducting device of claim 1 wherein said light unit has a negative-polarity bracket with a free end having a perpendicularly extended tip and a positive-polarity bracket with a free end being an arced head plate; upper ends respectively of said brackets being provided with supporting parts; each of said supporting parts further having a ring stopper with a guiding groove and a through hole at an terminal of said guiding groove for said insertion of the negative-polarity bracket, whereby said perpendicularly extended tip will be attached into said guiding groove of said supporting parts and a negative terminal of a set of batteries will be connected; an inwardly converging neck portion with a downwardly extending thin rod being extended from a lower end of said ring stopper, for being sandwiched between said brackets, whereby said ring stopper will be blocked on an upper face of an upper tube of said refill unit and said light emitting body will be inserted in a lower tube of said refill unit.

8. The bidirection-rotational conducting device of claim 1 wherein said rotational unit further includes a fixed retaining ring and a column erected on a top surface of said retaining ring; said retaining ring and said column having an internal receptacle space; a top surface of said column being provided with two adjacent retaining holes; a lower inner wall of said fixed retaining ring being provided with screwed section; an outer wall of said column forming a base for supporting a connecting body; said connecting body being provided with two oppositely bulged pieces and a guiding rail column with arced guiding rails on two lateral side thereof; each of said arced guiding rails being provided with a through hole going through said base.

9. The bidirection-rotational conducting device of claim 1 wherein said guiding rail column of said connecting body of said rotational unit are provided with a ring stopper with bulged pieces on a lateral wall thereof; a top surface of said ring stopper being provided with corresponding insertion portions respectively for the insertion of a B core component through one of said through holes on a left side of said arced guiding rails of said connecting body and insertion portions for the insertion of an A core component through one of said through holes on a right side of said arced guiding rails of said connecting body.

10. The bidirection-rotational conducting device of claim 1 wherein a supporting portion is formed on an internal wall of a shell of said rotational unit, whereby said supporting portion will follow an arced track defined by said arced guiding rails and will be eventually fixed by two lateral bulged pieces, and whereby a lower end of said supporting portion will be secured by a depressed retaining point; therefore, said shell being capable of controlling a sliding motion of said A core component and said B core component as a unified body and the extension and retreat of said refill about a pen nozzle.
